(19) United States
(12) Patent Application Publication
(10) Pub. No.: US 2002/0083470 A1
(43) Pub. Date: Jun. 27, 2002

(54) System and method for sending out-of-band service information to a host device

(75) Inventor: Jin Lu, Croton-on-hudson, NY (US)

Correspondence Address: Michael E. Marion, c/o U.S. PHILIPS CORPORATION, Intellectual Property Department, 580 White Plains Road, Tarrytown, NY, 10591, US

(73) Assignee: PHILIPS ELECTRONICS NORTH AMERICA CORPORATION

(21) Appl. No.: 09/745,622

(22) Filed: Dec. 21, 2000

(51) Int. Cl. H04N 7/173; H04N 7/08; H04N 7/084; H04N 7/087

(52) U.S. Cl. 725/136; 348/486; 725/139

(57) ABSTRACT

Method and system for sending out-of-band (OOB) service information from a point of deployment (POD) module to a set-top box in transport streams (TS) are disclosed by an arrangement in which the OOB service information is transmitted between the point of deployment (POD) module and a set-top box using the transport stream channel. The method includes constructing OOB TS packets using the OOB service information in the data module, buffering them and sending the OOB TS packets between two consecutive transport stream packets of an original in-bound (IB) transport stream.

### FIELD OF THE INVENTION

This invention relates to a system for sending out-of-band (OOB) service information and, more particularly, to a system for sending out-of-band service information from a data module, such as a point of deployment (POD) module, to a host system, such as a set-top box.

### BACKGROUND OF THE INVENTION

Digital video and audio consumer electronics/devices are used by consumers to receive and conduct numerous services and transactions, for example, to receive video, audio and data streams from a (cable television) service provider, such as Emergency Alerting, Interactive Program Guides, Impulse Pay-Per-View (IPPV), Video On Demand (VOD), General Messaging, and Interactive Services.

In particular, one such a host device is a set-top box. A data module, such as a point of deployment (POD) module is a removable card inserted into a host device. As is well known the art, a POD module provides several functions including security that is physically separate from a set-top box's navigation function and parsing out-of-band cable signals. For additional details on POD modules, see SOCIETY OF CABLE TELECOMMUNICATIONS ENGINEERS, INC. (SCTE) Document: SCTE DVS 131 Rev. 7, entitled “Draft Point-of-Deployment (POD) Module Interface Proposal” dated Dec. 3, 1998, (hereinafter known as “DVS131r7”).

Consumers rely on such devices to communicate, access programs and services or engage in commercial transactions.

As noted, a host device, such as a set-top-box (STB) or a cable-ready DTV receiver is used in conjunction with a point of deployment (POD) module to receive desired services. For example, the STB receives programs and services in the form of elementary streams from a service provider. The elementary streams are sent inside in-band (IB) transport streams to the STB and forwarded to the POD module so that scrambled programs can be descrambled by POD module. Thereafter, the transport streams are sent back to the host through the POD-to-host transport stream (TS) channel for demultiplexing and decoding.

The STB must receive service information (or electronic program guide) data from the service provider in order to navigate through the received services and programs. The service information on free services (e.g. must-carry broadcast programs) is carried in-band as part of transport streams. The service information on paid services (e.g. pay-per-view services) is carried out-of-band (OOB). The OOB service information is transmitted from the service provider to the POD module inside the OOB data. The OOB service information is retrieved from the OOB data by the POD module and delivered to the host.

The existing method for delivering OOB service information from a POD module to a host device is through a data channel, a so-called extended channel, between the POD module and the host device. The extended channel is separate from the POD-to-host transport stream (TS) channel for delivering transport streams.

This method has several shortcomings including that the host must process system information from different sources—the POD-to-host TS channel and the extended channel, and more importantly, that the bandwidth of the extended channel and the overhead associated with the way the extended channel works limits the throughput of the service information crossing the extended channel.

Thus, there is a clear and present need for an effective means to provide OOB service information from the POD module to the host in a less restrictive manner.

### SUMMARY OF THE INVENTION

It is an object of the present invention to provide OOB service information to a host device in the transport streams transmitted in a data module, such as a point of deployment (POD) module, to host device, such as a set-top box, via the transport stream channel.

It is a further object of the present invention to allow a host device to accommodate IB and OOB service information in a uniform way, wherein limited or no change is necessary for an existing host device to receive OOB service information carried with transport streams and using the IB POD-to-host TS channel that has increased bandwidth for carrying extra data than the extended channel.

The problems associated with delivering OOB service information from a data module to a host device are reduced or overcome by an arrangement in accordance with the principles of the invention in which the OOB service information delivered in the transport streams transmitted in a data module, such as a point of deployment (POD) module, to host device, such as a set-top box, via the transport stream channel.

### BRIEF DESCRIPTION OF THE DRAWING

The invention will be more readily understood after reading the following detailed description taken in conjunction with the accompanying drawing, in which:

FIG. 1 illustrates an exemplary system in accordance with the principles of the present invention; and

FIG. 2 is a flowchart depicting the process for delivering OOB service information from a data module to a host device using the transport stream channel in the system of FIG. 1.

### DETAILED DESCRIPTION

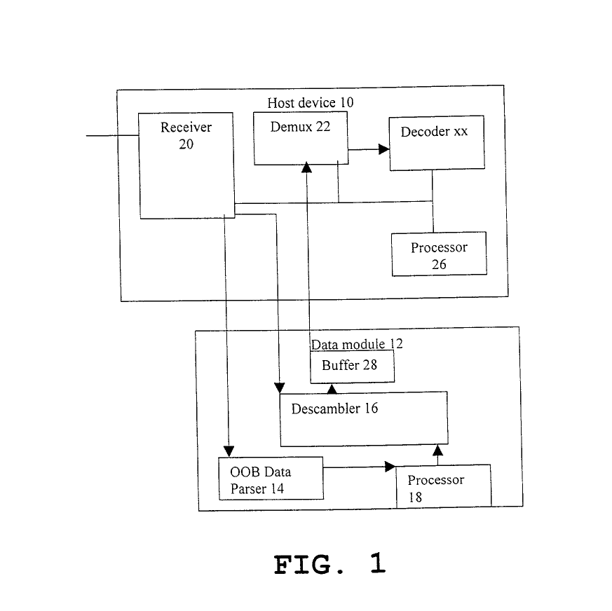

FIG. 1 is an exemplary system according to the principles of the present invention in which OOB service information delivered to a host device in the transport streams (TS) transmitted in a data module-to-host TS channel. It will be recognized that FIG. 1 is simplified for explanation purposes and that the full system environment for the invention will comprise, for example, a cable, fiber or satellite service provider network or provisions for network reliability through redundancy, all of which need not be shown here. The system illustratively includes a host device 10, such as a set-top box and a data module 12, such as a point of deployment (POD) module, which communicate with each other through a communication medium, for example, wireless communication, electromagnetic card interface, optical communication, and the like.

Data module 12, includes an out of band (OOB) data parser 14, descambler 16, buffer 28, and a processor 18.

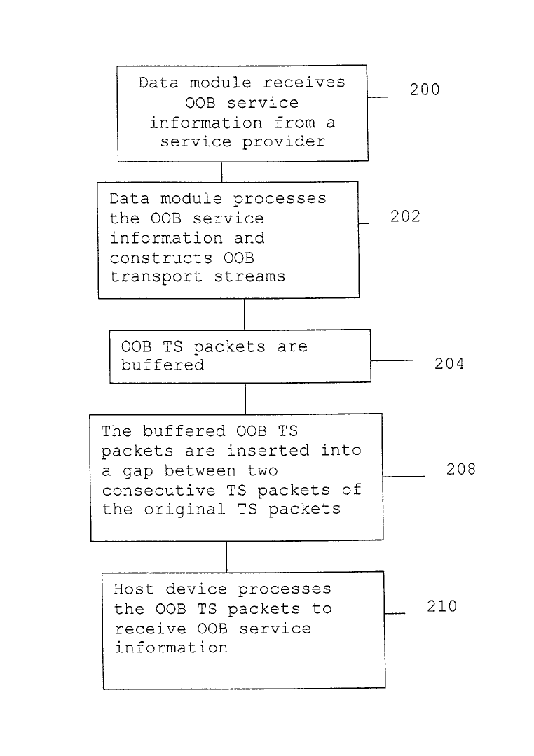

The majority of logic, control, supervisory, translation functions required for the operation of data module 12 is performed by processor 18 which also includes programs for the operations functionally described in FIG. 2. As described in detail below, execution of these program implements the functionality necessary to deliver OOB service information via the transport streams in the data module-to-host TS channel. Processor 18 can be any of a number of commercially available processors.

Although data module 12 is described as a POD, this arrangement is merely for convenience and it is to be understood that data modules are not limited to PODs, per se. As used herein, the term “data module” refers to any type of (1) point of deployment module, (2) wireless, cellular or radio data interface appliance, (3) smartcard (4) personal computer, and (5) internet interface appliance, which facilitates the transfer of data, access remote services or engage in transactions.

Host device 10 communicates with data module 12 through the communication medium. Host device 10 includes a receiver 20, to receive elementary streams from a server provider, a demultiplexer 22, decoder 24 and a processor 26.

Similar to the data module, the majority of logic, control, supervisory, translation functions required for the operation of the authentication center are performed by processor 26 which also includes programs for the operations functionally described in FIG. 2. As described in detail below, execution of these programs implements the functionality necessary to deliver OOB service information via the transport streams in the data module-to-host TS channel. Processor 26 can be any of a number of commercially available processors.

The principles of the present invention are particularly useful for the OOB service information delivery from a POD module to a Host in a service provider communications network, such as a cable television network. However, it is to be understood that the steps described below in FIG. 2 are equally applicable to other devices indicated above.

In particular, set-top-boxes with a slot for insertion of a POD module will soon be available. To allow the set-top-box to navigate through all the available services and programs, there must be a reliable and efficient way to deliver OOB system information from POD to Set-top-box. The spirit of video digital technology is to do as much as possible in the headend to simplify the receivers. POD modules can be viewed as an extension of a headend; they may be leased from service providers, e.g. MSOs, instead of being purchased by consumers. Thus in accordance with the present invention, the design of the host device is simplified by doing a data insertion in the POD module, thus making the host device design more reliable and efficient.

FIG. 2 is a flow chart showing the steps carried out within the system of FIG. 1 to implement sending OOB service information from a data module to a host device in the transport streams according to the principles of the present invention.

With simultaneous reference to FIGS. 1 and 2, the process contemplated by the invention is initiated in step 200 of FIG. 2, when a data module, for example data module 12 of FIG. 1, receives OOB service information, for example, from a service provider (not shown).

In step 202, data module 12 processes the OOB service information, for example, in a conventional manner and constructs OOB transport stream (TS) packets using the OOB service information. The OOB service information is formatted into transport stream packets, for example, in accordance with ITU-T Rec. H.222.0/ISO/IEC 13818-1 (1996-04), Information Technology—Generic Coding of Moving Pictures and Associated Audio Information Systems. Thereafter, the OOB TS packets are buffered in buffer 28, in step 204. Alternatively, if the OOB service information is delivered to the data module inside TS packets, no OOB TS construction is needed.

In step 208, the OOB TS packets from the buffer are inserted into a gap between two consecutive TS packets of the original TS packets. In particular, existing data throughput for IB transport stream delivered in IB POD-to-host device TS channel is less than 38 Mbps. The maximum data throughput for this channel is about 50 Mbps. Therefore, there is sufficient “space” between two consecutive TS packets of the original IB TS stream to insert the OOB TS packets. The OOB TS packets insertion occurs as soon as the gaps are available and such that the original TS packets are not delayed due to the insertion of the OOB TS packets.

For one example, to better understand how the OOB TS packets are inserted, assume the data throughput of the original TS packets is 38 Mbps (Mega bits per second), roughly 25266 TS packets per second, and the maximum data throughput for the IB channel, 50 Mbps, is roughly 33245 TS packets per second. (A TS packet has 188×8=1504 bits.) This means that we have room or gap for inserting roughly 8000 TS packets per second into the IB channel. Let us assume that we have 5000 packets per second to be inserted. To achieve this, we have, for example, a scheduler that makes sure that roughly for every 25299/5000=5 original TS packets sent, one OOB TS packet is sent.

Thereafter, in step 210, the host device processes the OOB TS packets to receive OOB service information.

The functions of the various elements shown in the FIGS. 1-2, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included.

The following merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, and the like represent various processes which may be substantially represented in computer readable medium and so executed by a computer or processor, whether or not such computer or processor is explicitly shown.

1. A system for sending out-of-band (OOB) service information from a service provider, the system comprising:
a point of deployment module which includes,
a processor for processing the OOB service information from a service provider, constructing OOB transport stream (TS) packets using the OOB service information and sending the OOB TS packets to a set-top box using a transport stream channel; and
wherein the set-top box includes a processor for processing the OOB TS packets.

2. The system of claim 1, wherein the point of deployment module further includes a buffer for storing the OOB TS packets.

3. The System of claim 2, wherein the point of deployment module sends the OOB TS packets between two consecutive transport stream packets of an original inbound transport stream.

4. A method of sending out-of-band (OOB) service information from a service provider between a data module a host device, the method comprising the steps of:
(a) receiving the out-of-band service information at the data module;
(b) constructing OOB transport stream (TS) packets using the OOB service information;
(c) inserting the OOB TS packets into a gap between two consecutive TS packets of the original TS packets; and
(d) receiving the OOB TS packets at the host device.

5. The method of claim 4, wherein the data module is a point of deployment module.

6. The method of claim 4, wherein the host is a set-top box.

7. A data module for use with a host device, the data module comprising:
a processor for processing out-of-band (OOB) service information, constructing OOB transport stream (TS) packets using the OOB service information and sending the OOB TS packets to a host device using a transport stream channel.

8. The data module of claim 7, further including a buffer for storing the OOB TS packets.

9. The data module of claim 8, wherein the data module sends the OOB TS packets between two consecutive transport stream packets of an original in-bound transport stream.

10. The data module of claim 7, wherein the data module is selected from the group consisting of a point of deployment module, wireless data interface appliance, smartcard, personal computer or internet interface appliance.

11. The data module of claim 7, wherein the host device is a set-top box.

12. A host device for use with a data module, the host comprising:
a processor for processing out-of-band (OOB) service information, wherein the OOB service information is received from OOB transport stream (TS) packets sent by the data module.

13. The host device of claim 12, wherein the host is a set-top box.

14. The host device of claim 13, wherein the processor is further adapted for receiving the OOB TS packets between two consecutive transport stream packets of an original in-bound transport stream.
